(19) United States
(12) Patent Application Publication
(10) Pub. No.: US 2024/0311744 A1
(43) Pub. Date: Sep. 19, 2024

(54) DELIVERY LOSS MITIGATION

(71) Applicant: INTERNATIONAL BUSINESS MACHINES CORPORATION, ARMONK, NY (US)

(72) Inventors: Uri Kartoun, Cambridge, MA (US); Sophie Batchelder, Cambridge, MA (US); Jeremy R. Fox, Georgetown, TX (US); Zachary A. Silverstein, Georgetown, TX (US)

(21) Appl. No.: 18/185,543

(22) Filed: Mar. 17, 2023

(51) Int. Cl. G06Q 10/0833; G06Q 30/0208

(52) U.S. Cl. CPC G06Q 10/0833; G06Q 30/0208

(57) ABSTRACT

Described is a method to mitigate delivery losses due to an item being delivered to an incorrect location. The method can receive from a first device associated with an observer, a notice that an item has been delivered to an incorrect location. In response to validating that the item has been delivered to the incorrect location, the method can determine a plurality of available remediation actions for the item that has been delivered to the incorrect location. The method can send to a second device associated with a recipient of the item, the plurality of available remediation actions, wherein each of the plurality of available remediation actions is selectable by the recipient of the item. In response to receiving, from the second device associated with the recipient of the item, a remediation action selection from the available remediation actions, the method can perform the remediation action selection.

### BACKGROUND

This disclosure relates generally to delivery services, and in particular to loss mitigation for delivery services.

In supply chain management, the last mile is a reference to a final portion of a journey for goods by a carrier between a transportation hub and a final destination. Deliveries for this final portion of the journey requires the distribution of the goods to various addresses within a given area and is often the portion of the journey where the goods deviate from an intended path to the final destination. These deviations, commonly known as misdeliveries, can occur due to an error by a carrier or missing information on an address label for the final destination. Misdeliveries not only affect an intended recipient of the goods, but also the carrier and the retailer providing the goods. Typically, the retailer would resend the goods to the recipient resulting in additional waiting time for the delivery, while either taking on the financial responsibility for the misdelivery or passing on the financial responsibility onto the carrier.

### SUMMARY

Embodiments in accordance with the present invention disclose a method, computer program product and computer system for delivery loss mitigation, the method, computer program product and computer system can receive from a first device associated with an observer, a notice that an item has been delivered to an incorrect location. The method, computer program product and computer system can, responsive to validating that the item has been delivered to the incorrect location, determine a plurality of available remediation actions for the item that has been delivered to the incorrect location. The method, computer program product and computer system can send to a second device associated with a recipient of the item, the plurality of available remediation actions, wherein each of the plurality of available remediation actions is selectable by the recipient of the item. The method, computer program product and computer system can, responsive to receiving from the second device associated with the recipient of the item, a remediation action selection from the available remediation actions, perform the remediation action selection.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart for a delivery loss mitigation program managing and resolving misdeliveries of items to a final destination, in accordance with an embodiment of the present invention.

FIG. 3 depicts an example scenario for a delivery loss mitigation program managing and resolving misdeliveries of items to a final destination, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

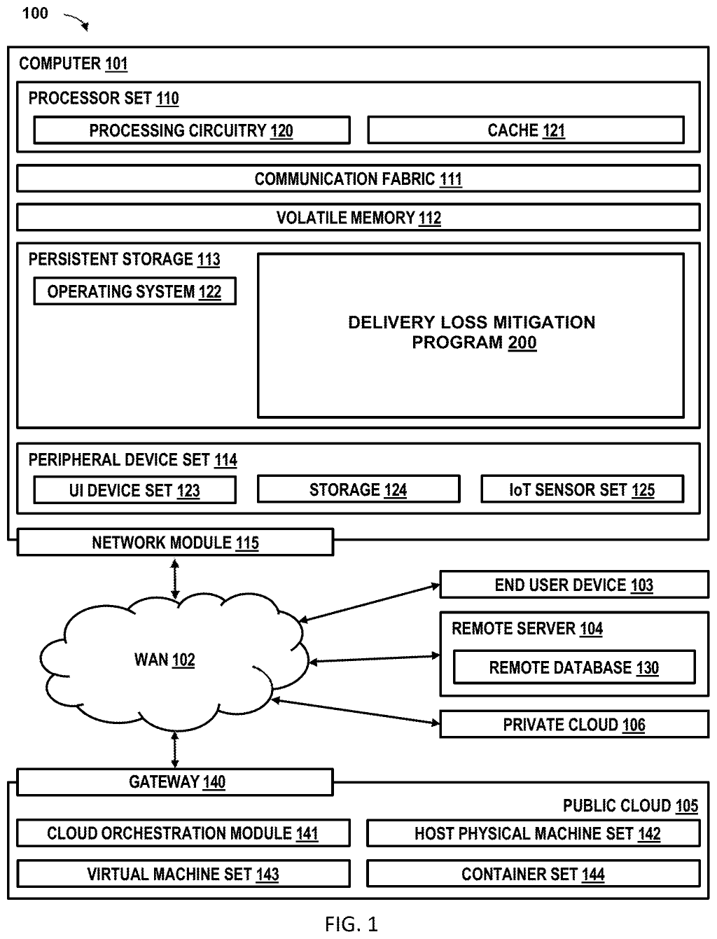

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, delivery loss mitigation program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

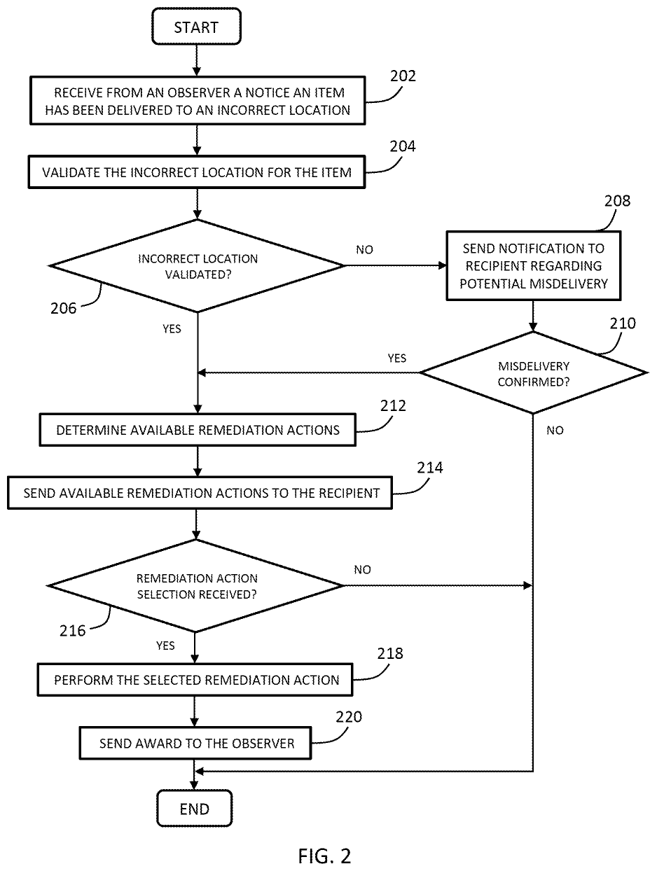

FIG. 2 depicts a flowchart for a delivery loss mitigation program managing and resolving misdeliveries of items to a final destination, in accordance with an embodiment of the present invention.

Delivery loss mitigation program 200 receives from an observer a notice an item has been delivered to an incorrect location (202). In one embodiment, the observer is a registered user of delivery loss mitigation program 200, where delivery loss mitigation program 200 receives, from the registered user, a notice that an item has been delivered to an incorrect location. Delivery loss mitigation program 200 allows for the registrations of users to reduce false reporting of items being delivered to the incorrect location, where the observer registers as a user by providing various identifying information. In one example, delivery loss mitigation program 200 registers the observer as a user by providing identifying information such as, a first name, a last name, a business and/or personal address, an email address, and a unique username. The notice that delivery loss mitigation program 200 receives can include identifying details such as, a geolocation for the observer, a photo of the item, a photo of the incorrect location, and any additional comments regarding the misdelivery of the item. The additional comments allow for the observer to provide details including but not limited to where the item is situated (e.g., front porch, lobby) at the incorrect location, a current state of the packaging (e.g., undamaged, damaged, open), a current state of the shipping label with a recipient's address (e.g., legible, illegible, missing), and an estimated amount of time the item has been at the incorrect location (e.g., two days). In another embodiment, the observer represents an anonymous person (i.e., non-registered user) from which delivery loss mitigation program 200 receives the notice an item has been delivered to an incorrect location. The non-registered user providing the notice to deliver loss mitigation program 200 can also be required to provide a one or more of the above-mentioned identifying information (e.g., an email address) and one or more of the above-mentioned identifying details (e.g., a geolocation for the observer) to ensure the notice is genuine.

Delivery loss mitigation program 200 can provide a user interface on a device associated with the observer, where the observer can scan and/or photograph a unique machine-readable pattern (e.g., barcode, quick response (QR) code) on a shipping label to associate the item with the notice for the delivery to the incorrect location. As the observer scans the unique machine-readable pattern on the shipping label for the item, delivery loss mitigation program 200 provides, via the user interface, multiple options for the observer to enter various identifying information and/or identifying details for the item that has been delivered to the incorrect location. Upon the observer entering the various identifying information and/or identifying details for the item in the user interface, the observer submits the information, and delivery loss mitigation program 200 receives the notice that the item associated with the scanned unique machine-readable pattern on the shipping label has been delivered to the incorrect location. In some embodiments, delivery loss mitigation program 200 can query the observer when receiving the notice that the item has been delivered to the incorrect location to determine whether the observer is able to redeliver the item to the recipient's address for credit towards a purchase from the seller of the item that has been misdelivered. For example, retailer A has shipped item B to a recipient's address and delivery loss mitigation program 200 receives from an observer a notice that item B has been delivered to an incorrect location. Delivery loss mitigation program 200 can query the observer to determine if the observer can redeliver item B to the recipient's address for credit (e.g., $5) for a future purchase from retailer A. Delivery loss mitigation program 200 can receive a selection from the observer indicating whether they are willing to redeliver item B for the credit for the future purchase from retailer A, if delivery loss mitigation program 200 receives the corresponding remediation action from the recipient of item B, discussed in further detail with regards to (decision 216). In some embodiments, to reduce fraudulent reports, delivery loss mitigation program 200 can limit a number of notices (e.g., 10) received from a specific observer in a given time frame (e.g., one month) and/or limit a distance between the incorrect location and a registered address for the observer, thus limiting the observer to a specific geographical area (e.g., single street, single apartment building).

Delivery loss mitigation program 200 validates the incorrect location for the item (204). In this embodiment, delivery loss mitigation program 200 validates the incorrect location for the item by comparing a recipient's address for the item to a geolocation for a device associated with observer. As previously mentioned, delivery loss mitigation program 200 can receive identifying details with the notice that includes the geolocation provided by the device associated with observer. To ensure the location for the observer is not manipulated or falsely provided, delivery loss mitigation program 200 utilizes global positioning systems (GPS) services provided directly from an operating system (OS) or verified third party application for the device associated with the observer. Delivery loss mitigation program 200 compares the recipients address for the item to the geolocation for the device associated with the observer and determines whether the geolocation for device associated with observer is beyond a threshold limit distance (e.g., 25 feet) from the recipient's address. In another embodiment, delivery loss mitigation program 200 validates the incorrect location for the item by comparing a recipient's address for the item to an observer provided location, where delivery loss mitigation program 200 previously received the observer provided location with the notice that the item has been delivered to the incorrect location.

Delivery loss mitigation program 200 determines whether the incorrect location is validated (decision 206). In the event delivery loss mitigation program 200 determines the incorrect location is not validated (“no” branch, decision 206), delivery loss mitigation program 200 sends a notification to the recipient regarding the potential misdelivery (208). In the event delivery loss mitigation program 200 determines the incorrect location is validated (“yes” branch, decision 206), delivery loss mitigation program 200 determines available remediation actions (212).

In the embodiment where delivery loss mitigation program 200 compares the recipient's address for the item to the geolocation for the device associated with the observer, delivery loss mitigation program 200 determines the incorrect location is validated when the threshold limit distance is met or exceeded between the recipient's address for the item and the geolocation for the device associated with the observer. Delivery loss mitigation program 200 determines the incorrect location is not validated when the threshold limit distance is not exceeded or if the comparison provides an inconclusive distance difference between the recipient's address for the item and the geolocation for the device associated with the observer. The inconclusive distance difference can occur due to poor geolocation services on the device associated with the observer and/or if the observer is located on a floor level different (e.g., floor 25) when compared to a floor level provided in the recipient's address (e.g., floor level 7). In the embodiment where delivery loss mitigation program 200 compares the recipient's address for the item to the observer provided location, delivery loss mitigation program 200 determines incorrect location is not validated due to the observer provided location being manually provided in the user interface with no verification from the device associated with the observer.

Delivery loss mitigation program 200 sends a notification to the recipient regarding the potential misdelivery (208). Since delivery loss mitigation program 200 was not able to validate that the item was delivered to the incorrect location, delivery loss mitigation program 200 sends the notification to a device associated with the recipient regarding the potential misdelivery. The notification can include the identifying information and identifying details associated with the notice provided by the observer for the item that has been delivered to the incorrect location. A type of notification can include but is not limited to a text message, an automated call, an in-application message, an application alert, and an email. In one embodiment, delivery loss mitigation program 200 sends a notification in the form of a text message to a device associated with the recipient, where the text message includes the geolocation provided by the device of the observer and a photo of the item (i.e., packaging) provided by the observer. Delivery loss mitigation program 200 requests that the recipient confirm the misdelivery due to delivery loss mitigation program 200 not being able to validate the incorrect location of the item. Delivery loss mitigation program 200 can also provide, with the notification, a selectable link to a home security application to access one or more cameras for an area (e.g., front porch, lobby entrance), where an item is typically delivered by a carrier at the recipient's location.

In another embodiment, delivery loss mitigation program 200 sends a notification in an application operating on the device associated with the recipient, where the notification includes the geolocation provided by the device of the observer, a name of the observer, and a comment provided by the observer (e.g., “package label is damage, missing apartment number”). Delivery loss mitigation program 200 requests that the recipient confirm the misdelivery due to delivery loss mitigation program 200 not being able to validate the incorrect location of the item due to the close proximate between the apartments within a single building. In yet another embodiment, delivery loss mitigation program 200 was not able to validate the incorrect location due to the threshold limited distance not being exceeded the recipient's address for the item and the geolocation for the device associated with the observer. Delivery loss mitigation program 200 sends a notification to the recipient stating that the item appears to have been delivered to the correct location (i.e., recipient's address) and to confirm if the notice regarding the misdelivery of the item to the incorrect location is accurate.

Delivery loss mitigation program 200 determines whether the misdelivery is confirmed by the recipient (decision 210). In the event delivery loss mitigation program 200 determines the misdelivery is confirmed by the recipient (“yes” branch, decision 210), delivery loss mitigation program 200 determines available remediation actions (212). In the event delivery loss mitigation program 200 determines the misdelivery is confirmed by the recipient (“no” branch, decision 210), delivery loss mitigation program 200 ceases operations for the received notice from the observer regarding the item being delivered to the incorrect location.

Delivery loss mitigation program 200 determines available remediation actions (212). Delivery loss mitigation program 200 can determine available remediation actions based on various factors such as, the geolocation of the observer where the item is currently located, a recipient's address for the item, a monetary value of the item, an internal carrier cost, an external carrier cost, an observer award cost, and an undelivered item cost. The monetary value of the item represents a final cost of the item paid by the recipient, excluding any additional carrier costs. The internal carrier cost represents a final cost for redelivering the item to the recipient's location utilizing an internal carrier and the external carrier cost represents a final cost for redelivering the item to the recipient's location utilizing an external carrier (i.e., third party). The observer award cost represents a final cost for providing monetary credit to purchase items being sold by the seller if the observer were to redeliver the item to the recipient's location. The undelivered item cost presents a final cost refunded to the recipient if the item is no longer needed. Available remediation actions can include the recipient traveling to the geolocation of the observer to collect the misdelivered item, the observer traveling to the recipient's address to deliver the item, allowing for an internal carrier to collect the item from the observer and attempt another delivery to the recipient's address, allowing for an external carrier to collect the item from the observer and attempt another delivery to the recipient's address, and issuing a refund for the total cost of the misdelivered item. Delivery loss mitigation program 200 can perform various cost analysis based on the various factors to determine which of the available remediation actions are financially viable and which of the available remediation actions are not financially viable when compared to the cost of the item and/or the other financially viable remediation actions.

Delivery loss mitigation program 200 sends the available remediation actions to the recipient (214). Delivery loss mitigation program 200 can send the available remediation action to the recipient, where the recipient is provided a specified time frame (e.g., one hour) to respond. The specified time frame allows for delivery loss mitigation program 200 to notify the observer regarding a selected remediation action by the recipient, specifically if the observer is to perform the redelivery of the item to the recipient's address. Thus, avoiding the observer handling the misdelivered item for an extended period of time, while awaiting the selection of a remediation action from the recipient of the item. Delivery loss mitigation program 200 can send the available remediation action to the recipient utilizing one or more notification types including but not limited to a text message, an automated call, an in-application message, an application alert, and an email. If one of the available remediation actions includes the observer redelivering the item to the recipient's address, delivery loss mitigation program 200 can include a photo from a registered user account associated with the observer, a first and/or last name of the observer, and a review rating from other recipients who have had misdelivered items delivered by the observer.

Delivery loss mitigation program 200 determines whether a remediation action selection was received (decision 216). In the event delivery loss mitigation program 200 determines a remediation action was received (“yes” branch, decision 216), delivery loss mitigation program 200 performs the selected remediation action (218). In the event delivery loss mitigation program 200 determines a remediation action was not received (“no” branch, decision 216), ceases operations for the received notice from the observer regarding the item being delivered to the incorrect location. Delivery loss mitigation program 200 can receive the selection of a remediation action based on the one or more notification types through which the available remediation actions were sent to the recipient by delivery loss mitigation program 200 in (214). Delivery loss mitigation program 200 can receive the selection of a remediation action via an input in a user interface on a device associated with the recipient (e.g., text message, in-application message) and/or a verbal input on the device associated with the recipient (e.g., automated call). As previously discussed, delivery loss mitigation program 200 can provide a specified time frame for the recipient to respond with the selection of a remediation action before one or more remediation actions are removed from the available remediation actions. For example, if delivery loss mitigation program 200 determines the specified time frame is exceeded, delivery loss mitigation program 200 removes a remediation action from the available remediation actions that includes the observer redelivering the item to the recipient's address, resulting in that remediation action no longer being selectable by the recipient of the item.

Delivery loss mitigation program 200 performs the selected remediation action (218). In one embodiment, delivery loss mitigation program 200 receives a selection for a remediation action that includes the observer redelivering the item to the recipient's address. Delivery loss mitigation program 200 sends a request to the observer to redeliver the item to the recipient's address and to provide one or more confirmation details that the item has been delivered to the recipient's address. Examples of a confirmation detail can include a geolocation for a device of the observer within the threshold limit distance of the recipient's address, a photo of the house number or apartment number for the recipient's address, and a photo of the item at the recipient's address near an object identifiable by the recipient (e.g., flowerpot, doormat). Upon delivery loss mitigation program 200 receiving the one or more confirmation details that the item has been delivered to the recipient's address by the observer, delivery loss mitigation program 200 sends a notification to the recipient indicating a successful delivery by the observer. In another embodiment, delivery loss mitigation program 200 receives a selection for a remediation action that includes the carrier redelivering the item to the recipient's address, where delivery loss mitigation program 200 schedule's a pickup of the item at the geolocation associated with the observer and instructs the carrier to redeliver the item to the recipient's address. Upon delivery loss mitigation program 200 receiving one or more confirmation details that the item has been delivered to the recipient's address by the carrier, delivery loss mitigation program 200 sends a notification to the recipient indicating a successful delivery by the carrier.

In yet another embodiment, delivery loss mitigation program 200 receives a selection for a remediation action that includes the recipient collecting the item from a geolocation for a device associated with the observer. Delivery loss mitigation program 200 provides multiple time frames for collecting from the observer based on availability and the geolocation for the device associated with the observer. Additionally, as previously discussed, delivery loss mitigation program 200 can include a photo from a registered user account associated with the observer, a first and/or last name of the observer, and a review rating from other recipients who have had misdelivered items delivered by the observer. Upon delivery loss mitigation program 200 receiving the one or more confirmation details that the item has been collected by the recipient from the observer (e.g., recipient provided photo of the item), delivery loss mitigation program 200 sends a notification to the recipient indicating a successful delivery by the recipient. In yet another embodiment, delivery loss mitigation program 200 receives a selection for a remediation action that includes the recipient requesting a refund for the item. Upon confirmation by delivery loss mitigation program 200 that a refund is issuable for the item, delivery loss mitigation program 200 sends a notification to the recipient indicating issuance of the refund. Additionally, delivery loss mitigation program 200 can send a request to the observer to return the item to a return address via a carrier or via a designated item drop-off area to receive credit towards a purchase from the seller of the item that has been misdelivered.

Delivery loss mitigation program 200 sends an award to the observer (220). Depending on the selected remediation action by the recipient and the successful redelivery of the item to the recipient, delivery loss mitigation program 200 sends an award to the observer and possibly the recipient. The award can include a credit towards a purchase from the seller of the item that has been misdelivered and/or a designated sum of money. An amount of credit and an amount of designated sum of money can each be based on the value of the item, a distance traveled between the geolocation of the device associated with the observer and the recipient's address, an urgency associated with the delivery (e.g., overnight shipping), a weight of the item, a size of the item, and/or weather conditions during the redelivery. In one example, delivery loss mitigation program 200 can send a larger award to the observer and/or recipient if the urgency associated with the redelivery was greater (e.g., overnight delivery) when compared to a redelivery with a lower associated urgency (e.g., standard shipping). In another example, delivery loss mitigation program 200 can send a larger award to the observer and/or recipient for a heavier item (e.g., x≥25 lbs.) that was redelivered compared to a lighter item (e.g., x<25 lbs.). In yet another example, delivery loss mitigation program 200 can send a larger award for a large distance traveled (e.g., e.g., x≥200 ft) between the geolocation of the device associated with the observer and the recipient's address when compared to a smaller distance traveled (e.g., e.g., x<200 ft) between the geolocation of the device associated with the observer and the recipient's address. An instance where both the observer and the recipient receive an award can include when delivery loss mitigation program 200 performs the selected remediation action where the recipient collects the misdelivered item from the geolocation associated with the device of the observer.

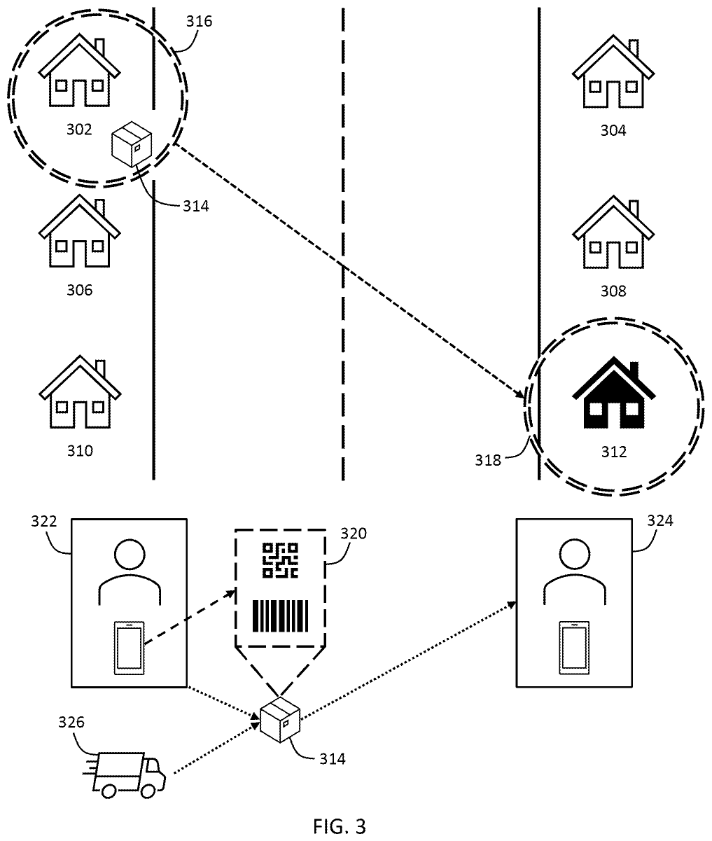

FIG. 3 depicts an example scenario for a delivery loss mitigation program managing and resolving misdeliveries of items to a final destination, in accordance with an embodiment of the present invention. Residences 302, 304, 306, 308, 310, and 312 line a street, where delivery loss mitigation program 200 receives a notice that item 314 has been delivered to an incorrect location of residence 302 rather than residence 312. Area 316 and 318 each define a threshold limit distance for residence 302 and 312, respectively. With the notice that item 314 has been delivered to the incorrect location, delivery loss mitigation program 200 receives a scan and/or photograph of unique machine-readable pattern 320 (barcode or QR code) on a shipping label of item 314 from observer 322. Delivery loss mitigation program 200 validates the incorrect location for the item by confirming a recipient's address based on the scanned and/or photographed unique machine-readable pattern 320 and confirming that a geolocation for a device associated with observer 322 where item 314 is located is beyond the threshold limit distance for residence 312, as defined by area 318. In response to validating the incorrect location for item 314, delivery loss mitigation program 200 determines available remediation actions and sends the available remediation actions to recipient 324. In this example, the available remediation actions include observer 322 redelivering item 314 to residence 312, recipient 324 collecting item 314 from the geolocation for the device associated with observer 322 where item 314 is located (i.e., residence 302), or carrier 326 collecting item 314 from residence 302 of observer 322 and redelivering item 314 to recipient 324 at residence 312. In response to receiving a selection to have observer 322 redeliver item 314 to residence 312, delivery loss mitigation program 200 perform the selected remediation action by sending a request to observer 322 to redeliver the package to residence 312 and a request to provide a photo of item 314 with an identifiable feature at residence 312, along with a geolocation tag from the device associated with observer 322. Upon receiving the photo of item 314 next to an identifiable feature (e.g., red door) at residence 312 and the geolocation tag from the device associated with observer 322, delivery loss mitigation program 200 sends an award to the observer for assisting with the redelivery of item 314.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, from a first device associated with an observer, a notice that an item has been delivered to an incorrect location;
responsive to validating that the item has been delivered to the incorrect location, determining a plurality of available remediation actions for the item that has been delivered to the incorrect location;
sending, to a second device associated with a recipient of the item, the plurality of available remediation actions, wherein each of the plurality of available remediation actions is selectable by the recipient of the item; and
responsive to receiving, from the second device associated with the recipient of the item, a remediation action selection from the available remediation actions, performing the remediation action selection.

2. The computer-implemented method of claim 1, further comprising:
comparing a geolocation for the first device associated with the observer to a recipient's address for the item; and
responsive to determining a distance limit threshold is exceeded between the geolocation for the first device associated with the observer and the recipient's address for the item, validating that the item has been delivered to the incorrect location.

3. The computer-implemented method of claim 1, further comprising:
comparing a geolocation for the first device associated with the observer to a recipient's address for the item;
determining whether a distance limit threshold is exceeded between the geolocation for the first device associated with the observer and the recipient's address for the item; and
responsive to not being able to determine that the distance limit threshold is exceeded between the geolocation for the first device associated with the observer and the recipient's address for the item, sending, to the second device associated with the recipient of the item, a notification regarding a potential misdelivery of the item, wherein the notification includes the notice from the observer.

4. The computer-implemented method of claim 1, wherein performing the remediation action selection further comprises:
sending, to the first device associated with the observer, a first request to redeliver the item to a recipient's address and a second request to provide at least one confirmation detail,
wherein the at least one confirmation detail is selected from the group consisting of: a geolocation for the first device associated with the observer within a distance threshold limit of the recipient's address, a photo of a house number for the recipient's address, a photo of an apartment number for the recipient's address, and a photo of the item at the recipient's address near an object identifiable by the recipient; and
responsive to receiving, from the first device associated with the observer, the at least one confirmation detail, sending, to the second device associated with the recipient of the item, a confirmation of a successful redelivery of the item to the recipient's address.

5. The computer-implemented method of claim 4, further comprising:
sending an award to the observer for the successful redelivery of the item to the recipient's address, wherein the award is selected from the group consisting of: a credit towards a purchase from a seller of the item and a designated sum of money.

6. The computer-implemented method of claim 1, wherein the notice includes identifying details selected from the group consisting of: a geolocation for the first device associated with the observer, a photo of the item, a photo of the incorrect location, and additional comments from the observer regarding delivery of the item to the incorrect location.

7. The computer-implemented method of claim 1, wherein the notice includes identifying information selected from the group consisting of: a first name of the observer, a last name of the observer, an address of the observer, an email address of the observer, and a unique username of the observer.

8. A computer program product comprising:
one or more computer-readable storage media;
program instructions, stored on at least one of the one or more storage media, to receive, from a first device associated with an observer, a notice that an item has been delivered to an incorrect location;
program instructions, stored on at least one of the one or more storage media, responsive to validating that the item has been delivered to the incorrect location, determine a plurality of available remediation actions for the item that has been delivered to the incorrect location;
program instructions, stored on at least one of the one or more storage media, to send, to a second device associated with a recipient of the item, the plurality of available remediation actions, wherein each of the plurality of available remediation actions is selectable by the recipient of the item; and
program instructions, stored on at least one of the one or more storage media, responsive to receiving, from the second device associated with the recipient of the item, a remediation action selection from the available remediation actions, perform the remediation action selection.

9. The computer program product of claim 8, further comprising:
program instructions, stored on at least one of the one or more storage media, to compare a geolocation for the first device associated with the observer to a recipient's address for the item; and
program instructions, stored on at least one of the one or more storage media, responsive to determining a distance limit threshold is exceeded between the geolocation for the first device associated with the observer and the recipient's address for the item, validate that the item has been delivered to the incorrect location.

10. The computer program product of claim 8, further comprising:
program instructions, stored on at least one of the one or more storage media, to compare a geolocation for the first device associated with the observer to a recipient's address for the item;
program instructions, stored on at least one of the one or more storage media, to determine whether a distance limit threshold is exceeded between the geolocation for the first device associated with the observer and the recipient's address for the item; and
program instructions, stored on at least one of the one or more storage media, responsive to not being able to determine that the distance limit threshold is exceeded between the geolocation for the first device associated with the observer and the recipient's address for the item, sending, to the second device associated with the recipient of the item, a notification regarding a potential misdelivery of the item, wherein the notification includes the notice from the observer.

11. The computer program product of claim 8, wherein program instructions, stored on at least one of the one or more storage media, to perform the remediation action selection further comprises:
program instructions, stored on at least one of the one or more storage media, to send, to the first device associated with the observer, a first request to redeliver the item to a recipient's address and a second request to provide at least one confirmation detail,
wherein the at least one confirmation detail is selected from the group consisting of: a geolocation for the first device associated with the observer within a distance threshold limit of the recipient's address, a photo of a house number for the recipient's address, a photo of an apartment number for the recipient's address, and a photo of the item at the recipient's address near an object identifiable by the recipient; and
program instructions, stored on at least one of the one or more storage media, responsive to receiving, from the first device associated with the observer, the at least one confirmation detail, send, to the second device associated with the recipient of the item, a confirmation of a successful redelivery of the item to the recipient's address.

12. The computer program product of claim 11, further comprising:
program instructions, stored on at least one of the one or more storage media, to send an award to the observer for the successful redelivery of the item to the recipient's address, wherein the award is selected from the group consisting of: a credit towards a purchase from a seller of the item and a designated sum of money.

13. The computer program product of claim 8, wherein the notice includes identifying details selected from the group consisting of: a geolocation for the first device associated with the observer, a photo of the item, a photo of the incorrect location, and additional comments from the observer regarding delivery of the item to the incorrect location.

14. The computer program product of claim 8, wherein the notice includes identifying information selected from the group consisting of: a first name of the observer, a last name of the observer, an address of the observer, an email address of the observer, and a unique username of the observer.

15. A computer system comprising:
one or more processors, one or more computer-readable memories and one or more computer-readable storage media;
program instructions, stored on at least one of the one or more storage media for execution by at least one of the one or more processors via at least one of the one or more memories, to receive, from a first device associated with an observer, a notice that an item has been delivered to an incorrect location;
program instructions, stored on at least one of the one or more storage media for execution by at least one of the one or more processors via at least one of the one or more memories, responsive to validating that the item has been delivered to the incorrect location, determine a plurality of available remediation actions for the item that has been delivered to the incorrect location;
program instructions, stored on at least one of the one or more storage media for execution by at least one of the one or more processors via at least one of the one or more memories, to send, to a second device associated with a recipient of the item, the plurality of available remediation actions, wherein each of the plurality of available remediation actions is selectable by the recipient of the item; and
program instructions, stored on at least one of the one or more storage media for execution by at least one of the one or more processors via at least one of the one or more memories, responsive to receiving, from the second device associated with the recipient of the item, a remediation action selection from the available remediation actions, perform the remediation action selection.

16. The computer system of claim 15, further comprising:
program instructions, stored on at least one of the one or more storage media for execution by at least one of the one or more processors via at least one of the one or more memories, to compare a geolocation for the first device associated with the observer to a recipient's address for the item; and
program instructions, stored on at least one of the one or more storage media for execution by at least one of the one or more processors via at least one of the one or more memories, responsive to determining a distance limit threshold is exceeded between the geolocation for the first device associated with the observer and the recipient's address for the item, validate that the item has been delivered to the incorrect location.

17. The computer system of claim 15, further comprising:
program instructions, stored on at least one of the one or more storage media for execution by at least one of the one or more processors via at least one of the one or more memories, to compare a geolocation for the first device associated with the observer to a recipient's address for the item;
program instructions, stored on at least one of the one or more storage media for execution by at least one of the one or more processors via at least one of the one or more memories, to determine whether a distance limit threshold is exceeded between the geolocation for the first device associated with the observer and the recipient's address for the item; and
program instructions, stored on at least one of the one or more storage media for execution by at least one of the one or more processors via at least one of the one or more memories, responsive to not being able to determine that the distance limit threshold is exceeded between the geolocation for the first device associated with the observer and the recipient's address for the item, sending, to the second device associated with the recipient of the item, a notification regarding a potential misdelivery of the item, wherein the notification includes the notice from the observer.

18. The computer system of claim 15, wherein program instructions, stored on at least one of the one or more storage media for execution by at least one of the one or more processors via at least one of the one or more memories, to perform the remediation action selection further comprises:
program instructions, stored on at least one of the one or more storage media for execution by at least one of the one or more processors via at least one of the one or more memories, to send, to the first device associated with the observer, a first request to redeliver the item to a recipient's address and a second request to provide at least one confirmation detail,
wherein the at least one confirmation detail is selected from the group consisting of: a geolocation for the first device associated with the observer within a distance threshold limit of the recipient's address, a photo of a house number for the recipient's address, a photo of an apartment number for the recipient's address, and a photo of the item at the recipient's address near an object identifiable by the recipient; and
program instructions, stored on at least one of the one or more storage media for execution by at least one of the one or more processors via at least one of the one or more memories, responsive to receiving, from the first device associated with the observer, the at least one confirmation detail, send, to the second device associated with the recipient of the item, a confirmation of a successful redelivery of the item to the recipient's address.

19. The computer system of claim 18, further comprising:
program instructions, stored on at least one of the one or more storage media for execution by at least one of the one or more processors via at least one of the one or more memories, to send an award to the observer for the successful redelivery of the item to the recipient's address, wherein the award is selected from the group consisting of: a credit towards a purchase from a seller of the item and a designated sum of money.

20. The computer system of claim 15, wherein the notice includes identifying details selected from the group consisting of: a geolocation for the first device associated with the observer, a photo of the item, a photo of the incorrect location, and additional comments from the observer regarding delivery of the item to the incorrect location.
